(19) United States
(12) Patent Application Publication
(10) Pub. No.: US 2014/0226195 A1
(43) Pub. Date: Aug. 14, 2014

(54) Method of modifying radiation characteristic of an excited emitter

(71) Applicants: Kareem Elsayad, Vienna (AT); Katrin Heinze, Wuerzburg (AT); Alexander Urich, Vienna (AT)

(72) Inventors: Kareem Elsayad, Vienna (AT); Katrin Heinze, Wuerzburg (AT); Alexander Urich, Vienna (AT)

(73) Assignee: BOEHRINGER INGELHEIM INTERNATIONAL GMBH, Ingelheim am Rhein (DE)

(21) Appl. No.: 14/009,359

(22) PCT Filed: Apr. 13, 2012
(86) PCT No.: PCT/EP12/56749

§ 371 Date: Jan. 23, 2014

(30) Foreign Application Priority Data
Apr. 14, 2011 (EP) 11162476.3

(51) Int. Cl. G02B 5/00

(52) U.S. Cl. CPC G02B 5/008
USPC 359/241

(57) ABSTRACT

A method of modifying a radiation characteristic of an excited emitter (2) and a layer structure (1) therefore, wherein the emitter (2) is placed in the vicinity of a layer structure (1) comprising a metal material, such that the emitter (2) couples to a surface state of the layer structure (1), in particular a surface plasmon polariton, which modifies the radiation characteristic of the emitter (2), wherein the layer structure (1) comprises a metal layer (3) sandwiched between a non-metal superstrate layer (4) and a non-metal substrate layer (5), wherein at least the metal layer (3) and the superstrate layer (4) are separated by a smooth interface (8) with a root mean square roughness equal to or less than 1 nanometer, and wherein the metal layer (3) has a thickness of between 1/100 and 1/20 in relation to an emission wavelength (λ′) of the emitter (2).

This invention relates to a method of modifying radiation characteristic of an excited emitter, wherein the emitter is placed in the vicinity of a layer structure comprising a metal material, such that the emitter couples to a surface state of the layer structure, in particular a surface plasmon polariton, which modifies the radiation characteristic of the emitter.

The invention further relates to a layer structure with a metal material for modifying a radiation characteristic of an excited emitter placed in the vicinity thereof by coupling between the emitter and a surface state of the layer structure, in particular a surface plasmon polariton.

In the art, a number of techniques based on surface plasmon enhanced emission have been proposed. Surface plasmons are collective excitations of free electrons near a metal/non-metal interface, which stem from the broken translational invariance in the direction perpendicular to the surface. A surface plasmon may couple to a photon, thereby forming a surface plasmon polariton (SPP). It has been found that the emission characteristics of an emitter are modified in the presence of a plasmonic surface, as the surface plasmon modes significantly change the electromagnetic field of the emitter/surface system. This effect has been successfully used for improving imaging methods, which rely upon the detection of luminescence phenomena (fluorescence, phosphorescence, etc.). A review of the state of the art is given in the article “Surface enhanced fluorescence”, E. Fort et al., J. Phys. D: Appl. Phys. 41 (2008), the full disclosure of which is herewith incorporated by reference. In surface enhanced fluorescence, the presence of the plasmonic surface significantly increases the molecular detection efficiency by modifying the electromagnetic environment of the emitters, typically fluorophores in a sample. It is well known that the total decay rate of an excited state molecule can be increased by placing it in the vicinity of a structure that increases the photonic mode density (PMD), i.e. the number of states that it can couple to. The increase in the PMD due to coupling with surface plasmon polaritons (SPP) has aroused particular interest with respect to energy loss compensation and overcompensation.

In order to increase the effective radiative decay rate from an excited emitter, such as a fluorescent dye, it is necessary to couple out the SPP into the radiation field. This may be achieved with a high refractive index substrate or superstrate material. A frequently used set-up is known as the “Kretschmann configuration”, which provides typically for a three-layer stacking glass/metal/dielectric, as disclosed in the above cited reference by E. Fort et al. The outcoupling of the modified radiation is through a glass prism, which has a higher refractive index than the dielectric superstrate. As a drawback of this approach, the geometry of the prism is not suitable for many large scale or highly integrated applications. Furthermore, the fabrication of non-planar and extensive substrates (e.g. prisms) is often impractical and expensive.

An alternative approach relies upon the scattering of the SPPs from sub-wavelength scale structures. These sub-wavelength structures may comprise particles, rough areas, gratings, discontinuities, photonic band-gaps, metal islands, etc. A local excitation field enhancement has also been described for microcavities, localized surface plasmons on nanoparticles, subwavelength apertures, plasmonic nano-antennae, or “hot-spots” on metallic fractal structures, or metal islands. In this case, the increased radiative emission largely originates from the structure itself. As a consequence, the lateral resolution is limited by the design of the scattering device, which is unfavorable for high sensitivity applications, e.g. applications that would require single molecule detection.

As an example for field enhancement using metal nanostructures, US 2010/0035335 A1 discloses a technique for enhancing the intrinsic fluorescence of biomolecules, wherein a solid substrate is coated with a nanostructured metal layer, on top of which an optional layer made of SiO₂ may be provided. The nanostructured metal layer may be in the form of particles, films or the like. The sample is excited with a radiation source and the fluorescence is measured with a detector.

It is now an object of the invention to reduce or overcome at least some of the beforementioned shortcomings of known surface enhanced emission techniques. In particular, it is an object of the invention to efficiently modify the emission properties in the vicinity of a layer structure in view of high-resolution measurements.

This object is achieved for a method and a layer structure, as initially defined, by providing for a layer structure comprising a metal layer sandwiched between a non-metal superstrate layer and a non-metal substrate layer, wherein at least the metal layer and the superstrate layer are separated by a smooth interface with a root mean square roughness equal to or less than 1 nanometer, and wherein the metal layer has a thickness of between 1/100 and 1/20 in relation to an emission wavelength of the emitter.

Thus, the near-field and far-field emission properties of nearby emitters are modified by a layer structure with an ultrathin smooth metal layer arranged between two non-metal layers, namely a substrate layer and a superstrate or top layer. The emitter or an ensemble of emitters are placed upon the layer structure, in particular the superstrate layer. For exciting the emitter, i.e. lifting the electronic structure of the emitter from its equilibrium ground state to an excited state, an excitation radiation of a suitable excitation wavelength is used. In the presence of the layer structure, the radiation emerging from the excited emitter, which has at least one emission wavelength, is modified as compared to the emitted radiation that would be obtained without the layer structure. The modification effect of the layer structure may comprise amplification, i.e. an increase in intensity, at the emission wavelength of the emitter. However, the emitted radiation may also be modified with respect to a change in the angular and spectral distribution of the emitted radiation. The modified radiation from the emitter may then be detected, measured or used as an input of a device. In the layer structure, the substrate layer and the superstrate layer are made of a non-metal, i.e. a dielectric or semiconducting, material. At least the interface between the metal layer and the non-metal superstrate layer has a root mean square (RMS) roughness of less than 1 nanometer (nm), preferably less than 0.5 nm. Preferably, the RMS roughness of the interface between the substrate layer and the metal layer is below 1 nm, too. The surface of the superstrate layer is less critical as to the upper boundary for the required smoothness; however, it is preferable, if the surface of the superstrate layer has a RMS smoothness of less than 1 nm, too. On the other hand, the thickness of the metal layer, which is arranged between the non-metal substrate and the non-metal superstrate layer, is determined by the emission wavelength of the emitter. In order to observe an advantageous modification/enhancement of the emission characteristics of the emitter, the thickness of the metal layer is between 1/100 to 1/20 of the emission wavelength of the emitter, which is modified in the presence of the layer structure. It is preferable if the metal layer is formed by a continuous layer, which adjoins the neighbouring non-metal layers at planar interfaces. The metal layer is preferably devoid of any lateral structurings. The superstrate layer and/or the substrate layer preferably have planar or curved interfaces. Furthermore, it is advantageous, if the metal layer is homogeneous on the order of the propagation distance of the surface state that couples to the emitter. In many prior art methods, rough surfaces/interfaces or other forms of discontinuities were used for scattering the surface plasmon polaritons (SPPs) into propagating waves. The propagating waves radiate and cause comparatively weak local field enhancements at the excitation emission wavelength. Whilst the increase in the excitation field is still signficant, the observed enhancement in these cases is largely due to the scattered (radiating) surface plasmons as opposed to the intrinsic increase in the radiative emission from the emitter itself due to an increased excitation field. Discontinuities in the nearby surface were also used as a way to excite SPPs at normal incidence and for outcoupling of the SPPs from the structure. On the other hand, it is known that smooth metal films normally quench fluorescence. However, as an important aspect of the invention, it was surprisingly found that an advantageous modification of the emission characteristic is obtained provided that an ultrathin metal layer is arranged between two non-metal layers and the interface between the metal layer and the non-metal superstrate layer is smooth with an RMS roughness of equal to or less than 1 nm. The modification of the emitted radiation in the presence of this layer structure results from the surface state being localized and reaching out of the layer structure, such that coupling between the emitter and the surface state is improved. As a further advantage, the comparatively simple layer structure allows for a cost-efficient production. Also, the layer structure can be produced with such a high accuracy, preferably in a sub-micron range, that precise quantitative measurements and integrated applications can be achieved. Moreover, the layer structure may easily be tuned for a particular application, which comprises providing a metal layer with an appropriate thickness, depending on the emission wavelength that is modified by the presence of the layer structure.

In a preferred embodiment of the invention, the smooth interface is produced by deposition of a wetting layer onto the substrate layer. As the interface between the metal layer and the non-metal superstrate layer has to be smooth on the scale of the wavelength of the surface excitation (in particular a surface plasmon polariton), many conventional deposition techniques (magnetron sputtering, evaporation, etc.) do not under conventional operation achieve the required interface smoothness. However, depositing a wetting layer, such as Ge or Cr on the substrate prior to the metal layer will result in the smoothness of the upper metal interface (as presently formed) being reduced by more than an order of magnitude. As a consequence, the required interface smoothness defined by an RMS roughness of less than 1 nm can be achieved. In particular, the RMS roughness can be lower than 0.4 nm. Preferably, additional short-time annealing at moderate temperatures of the layer structure as presently formed further improves the smoothness of the interface and also significantly reduces the bulk dielectric losses of the metal. The wetting layer typically has a thickness of less than 1 to 2 nm.

Also, the smooth interface between the metal layer and the superstrate layer in the final layer structure can be produced in a template stripping method. Such template stripping methods are per se known in the prior art and are used for fabricating very smooth metal films. In this method, a metal film is stripped off from a suitable template. The smoothness of the resulting surface depends on the smoothness of the template and may be on the scale of angstroms for stripping from a silicon wafer or from a template face that coincides with a crystal axis.

In a particularly preferred embodiment of the invention, the template stripping method is used together with a wetting layer, such that both sides of the metal layer form a smooth (i.e. having a RMS roughness of equal to or less than 1 nm) interface with the neighboring non-metal layers.

The main steps in this combined technique for preparing the layer structure are preferably as follows:

1) Preparing a template/wetting layer, preferably made from a Ge wafer,

2) optionally washing the template/wetting layer in a piranha solution (to create a thin oxide layer for facilitating the peeling);

3) depositing the metal layer on top of the template/wetting layer e.g. by PVD;

4) depositing a first dielectric material thereon,

5) covering the first dielectric material with an adhesive layer (e.g. from a polymer), thereby forming the substrate;

6) peeling off the layer structure as presently formed from the template/wetting layer;

7) turning the layer structure as presently formed around so that the metal layer is on top; and

8) depositing a second dielectric material (e.g. Si₃N₄) on top of the newly formed metal surface, thereby obtaining the finalized layer structure.

In this case, it is preferable if a germanium wafer is taken as a wetting layer. As a result, the lower interface of the metal layer will be as smooth as the Ge wafer, whereas the upper interface will be as smooth as if the sample was grown on a Ge wetting layer. The reason the latter is the case is because the smoothness achieved by the wetting layer is largely due to the energetic properties (free energy) of the wetting layer and not only the fact that it is thin and/or discontinuous. Annealing of the deposited metal prior to stripping may be used to improve its dielectric properties.

For enhancing the radiation from the emitter in the vicinity of the layer structure, it is preferable if a permittivity of the superstrate layer differs from a permittivity of the substrate layer, so that an asymmetric layer structure is formed. For an emitter with a quasi-continuous excitation spectrum around a cut-off energy E_{c} of the SPP, the parameters for the layer structure are preferably calculated with equations (1), (1a), (1b) and (1c), wherein the indices i,j=1, 2, 3, 4 refer to the substrate layer, the metal layer, the superstrate layer and a medium comprising the emitter, respectively, and k_{zi} is the transverse (i.e. perpendicular to the layer structure) component of the wavevector for the i^{th} layer, dᵢ is the thickness of the i^{th} layer, m is an integer, ∈ᵢ is the complex permittivity (with a real and an imaginary part) of the i^{th} layer, W₊ and W₋ is given by equation (1a) where R₁₂ are the Fresnel reflection coefficients, which for P-polarizations (which are responsible for exciting the SPPs) are given by equation (1b).

$$\begin{matrix}exp [ 2 i ( {k}_{z 3} {d}_{3} - π m ) ] = \frac{{ɛ}_{2} {k}_{z 3} {W}_{+} + {ɛ}_{3} {k}_{z 2} {W}_{-}}{{ɛ}_{2} {k}_{z 3} {W}_{+} - {ɛ}_{3} {k}_{z 2} {W}_{-}} & ( 1 ) \\ {W}_{\pm } = {R}_{12} \pm exp ( i {k}_{z 2} {d}_{2} ) & ( 1 a ) \\ {R}_{ij} = ( {ɛ}_{j} {k}_{zi} + {ɛ}_{i} {k}_{zj} ) ( {ɛ}_{j} {k}_{zi} - {ɛ}_{i} {k}_{zj} ) & ( 1 b )\end{matrix}$$

The wavevector k_{zi} is given by equation (1c), wherein the index i=1, 2, 3, 4 again refers to the substrate layer, the metal layer, the superstrate layer and the medium comprising the emitter, respectively, ω_{c} is an excited-ground state transition frequency of the emitter, which is proportional to its transition energy E_{c}, and c is the speed of light. The value of ω_{c} should lie within the finite emission spectrum of the emitter, and preferably close to its peak free-space radiative emission frequency.)

k_{zi}=(∈ᵢ−∈₄)²/ω_{c}/c (1c)

Layers 1 and 4, i.e. the substrate layer and the medium immediately surrounding the emitter, are taken to be semi-infinite in extent. Using equations (1) to (1c) for dimensioning the layer structure results in an increased intensity of the emitted radiation. Table 1 shows three preferred parameter combinations for layer-2 (metal layer) and layer-3 (a high-E superstrate layer) that obey the conditions set out in equations (1) to (1c). The transition frequencies ω are given in terms of the transition energy (eV).

In the preferred examples of table 1, the substrate layer (i=1) and the medium comprising the emitter (i=4) are assumed to be quartz (∈₁=2.13) and an immersion oil (∈₄=2.45), respectively.

| transition ω, eV | layer-2 [d₂ (nm)] | layer-3 [d₃ (nm)] |
|---|---|---|
| 1.9 (~redish) | Au [9] | SiC [22] |
| 2.4 (~greenish) | Ag [15] | Si₃N₄ [9] |
| 450 (~blueish) | Al [7] | Si(II)O [12] |

Preferably, the metal layer is formed by a metal material selected from the group consisting of silver, gold, palladium, nickel, chromium, aluminium, aluminium-zinc-oxide, gallium-zincoxide, cadmium or an alloy or mixture thereof. These metal layers are particularly suitable for enhancing radiation with emission wavelengths ranging from near ultraviolet to wavelengths for telecommunication. In many cases, alloys including silver/gold or cadmium/old may be desirable.

For enhancing the emission characteristics of the emitter over a broad range of emission wavelengths, it is advantageous if the non-metal superstrate layer is formed by a material selected from the group consisting of aluminium oxide, silicon dioxide, titanium dioxide, silicon nitride, silicon carbide, or a polymer. Thus, possible dielectric materials for the “load” or superstrate layer stretch over a comparatively large range of values for the permittivity. The material for the superstrate layer preferably depends on the material of the substrate layer and the sample medium. For the case of a low permittivity substrate (with a permittivity ∈<2.2), the superstrate layer is preferably made from aluminium oxide, silicon dioxide, titanium dioxide, and other low-∈ gate dielectrics. Furthermore, it can be preferable to use an organic or inorganic polymer. For a higher permittivity substrate layer (with a permittivity ∈>2.2), it is preferable to provide for a dielectric superstrate layer with a comparatively high permittivity, such as silicon nitride, silicon carbide, or a high-K gate dielectric. The given dielectric materials are advantageously combined with the metal materials listed before and can be used in a comparable wavelength range.

The modification of the emission characteristics is particularly pronounced in case the emitter emits radiation at an emission wavelength of between 250 nm and 1600 nm, preferably between 405 nm and 600 nm. Thus, this preferred embodiment encompasses the modification or enhancement of visible light emerging from an emitter.

In a preferred embodiment of the invention, the modified radiation from the emitter in the vicinity of the layer structure is used for imaging of a sample comprising the emitter. In this case, the radiation from the emitter is detected through an imaging system and processed in any known method to obtain an image of the sample. The presence of the layer structure in the vicinity of the emitter modifies the emission characteristics of the emitted radiation. In particular, an increased intensity in the radiation from the sample can be used to increase the resolution, in particular the lateral resolution, of the obtained images.

Preferably, the imaging of the sample is performed with a microscope arrangement comprising a microscope slide, which is coated with or consists of the layer structure for modifying the radiation from the sample comprising the emitter placed upon the superstrate layer of the layer structure. Thus, it is possible to improve investigations under microscopes by using a microscope slide comprising the layer structure. In a preferred embodiment, a microscope slide comprises a substrate plate, preferably made of quartz, which is coated with a layer structure as previously described.

In the application of the layer structure to imaging a sample comprising the emitter, it is preferable if the emitter is a fluorophore emitting fluorescent light, in particular a fluorescent dye. The design of the layer structure ensures that SPPs in the layer structure do not scatter but are localized. As a consequence, the emission/excitation wavelength of the emitter may be close to a cut-off energy, such that the SPPs may diverge into the area above the superstrate layer. In this region, a large number of emitters can then excite the SPPs, such that an enhanced field arises near the interface. Thus, emitters at certain distances from the interface are enhanced instead of quenched, as would normally be expected for a smooth metal layer. According to an important aspect of the invention, a comparatively large number of emitters may couple to the SPPs, thereby creating a strong field, which gradually falls off with the distance from the superstrate layer. Usually, for increasing the intrinsic radiation, the excitation energy is raised. On the other hand, in a preferred embodiment of the invention, emitters further away from the layer structure may significantly increase the excitation energy for the emitters closer to the layer structure. Thus, the configuration may allow for a pumping of the emitters closer to the layer structure. As a consequence, a relative modification/enhancement between emitters perpendicular to the surface of the layer structure is obtained, which results in an improved overall modification of the emission characteristics of the emitter. This effect is only achieved under the condition that the interface between the thin metal layer and the superstrate layer is smooth, as the modification/enhancement effect would vanish in case of discontinuities (nanostructures, gratings, islands, etc.) or rough interfaces, as provided for in many prior art configurations.

In a further preferred embodiment of the invention, the modified radiation from the emitter in the vicinity of the layer structure is used for determining a position of the emitter and/or for measuring a distance between the emitter and the layer structure. For example, cells (e.g. fibroblasts) can be marked with a fluorescent marker (e.g. Green fluorescent protein, GFP) at two different adhesion sites. A change in a short wavelength emission relative to a long wavelength emission can then be used to infer the distance from the layer structure. Due to the increased resolution achieved with the layer structure in the vicinity of the sample, it is possible to study the dynamics of the marked cells with very high accuracy.

In a still further embodiment of the invention, the modification of the radiation characteristic of the emitter in the ylcinity of the layer structure is used for bandpass or bandstop filtering. In the presence of the layer structure, the higher frequencies of a continuous band excitation field are attenuated, whereas a band of intermediate or lower frequencies the reflected energy is amplified due to the enhancement effect achieved with the layer structure as described above. Typically, the frequencies below a certain lower threshold are attenuated, too. Thus, the excitation field undergoes bandpass/bandstop filtering, which yields a filtered spectrum in the radiation from the emitter. This effect may in principle be used in different applications (optical devices etc.) that rely upon the transformation of a broadband input radiation into a filtered output radiation.

In a still further embodiment of the invention, the modification of the radiation characteristic of the emitter in the vicinity of the layer structure is used for stimulated emission of radiation from the emitter. In this case, the presence of the layer structure results in a population inversion among a plurality of emitters, which is due to the pumping of emitters close to the layer structure through emitters further away from the layer structure. As has been outlined before, this effect is achieved by providing an ultra-thin metal layer with a smooth interface between two non-metal layers. As a consequence, the layer structure may be used for all kinds of devices which rely upon stimulated emission, in particular lasing, spasing or similar techniques.

In the following, the invention will be explained in even more detail by way of a preferred exemplary embodiment illustrated in the drawings, yet without being restricted thereto. In detail, in the drawings:

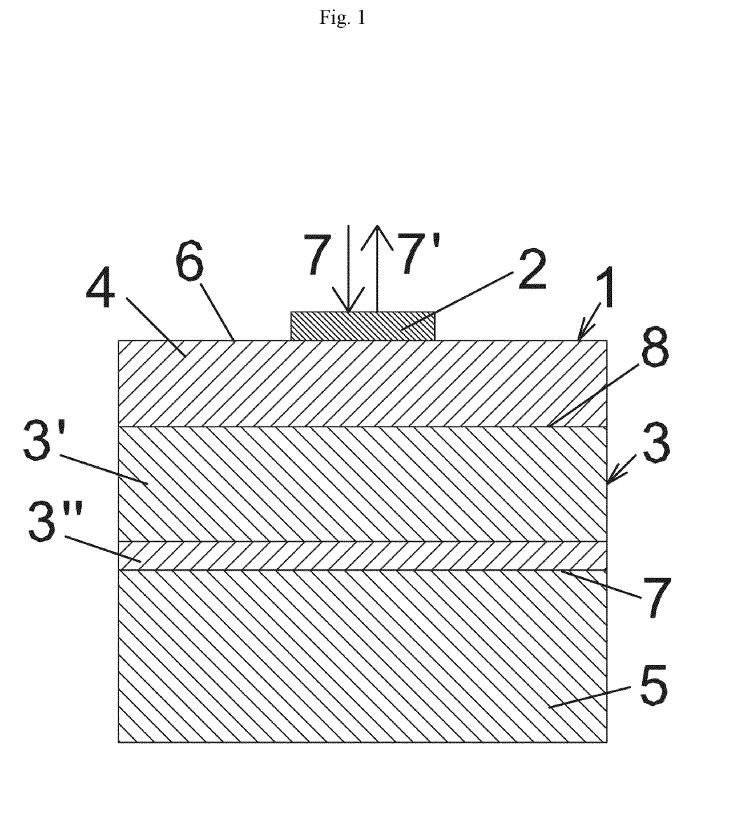

FIG. 1 schematically shows a layer structure for modifying the radiation from a nearby emitter according to the invention;

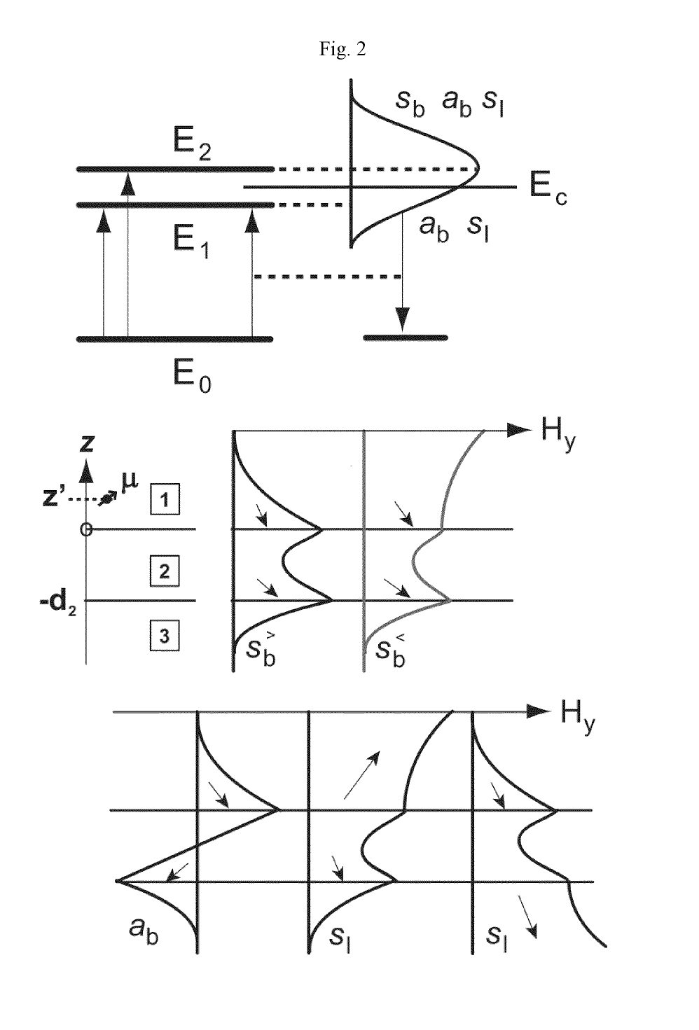

FIG. 2 shows a Jablonski energy diagram for illustrating the enhancement of the radiation emerging from a fluorescent dye in the presence of the layer structure according to FIG. 1;

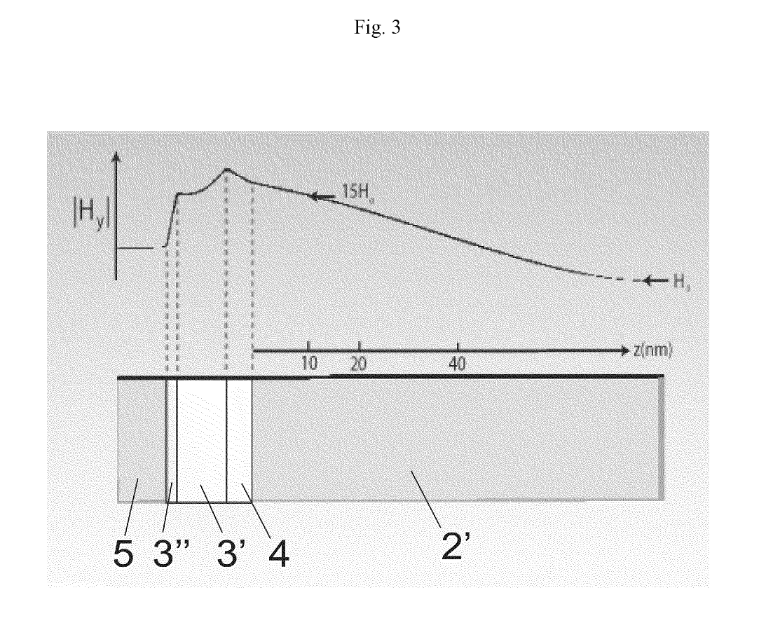

FIG. 3 schematically shows a transverse magnetic field profile for a long ranged surface plasmon polariton mode across the layer structure according to FIG. 1;

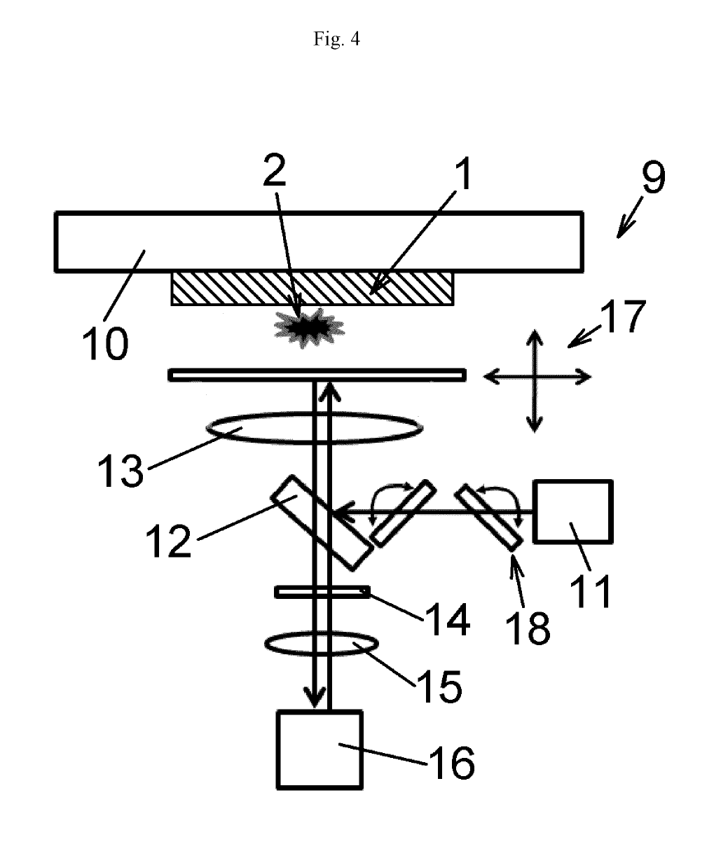

FIG. 4 schematically shows an arrangement for detecting radiation from an emitter on top of a layer structure according to FIG. 1;

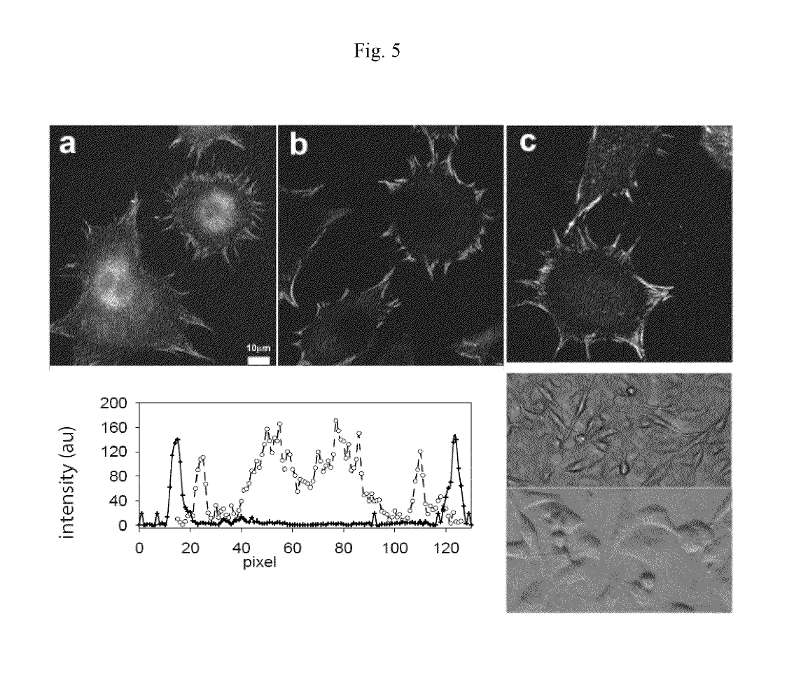

FIG. 5 shows images of fluorescent dye labeled paxillin in NIH 3T3 cells on a conventional substrate and on a layer structure according to FIG. 1, respectively;

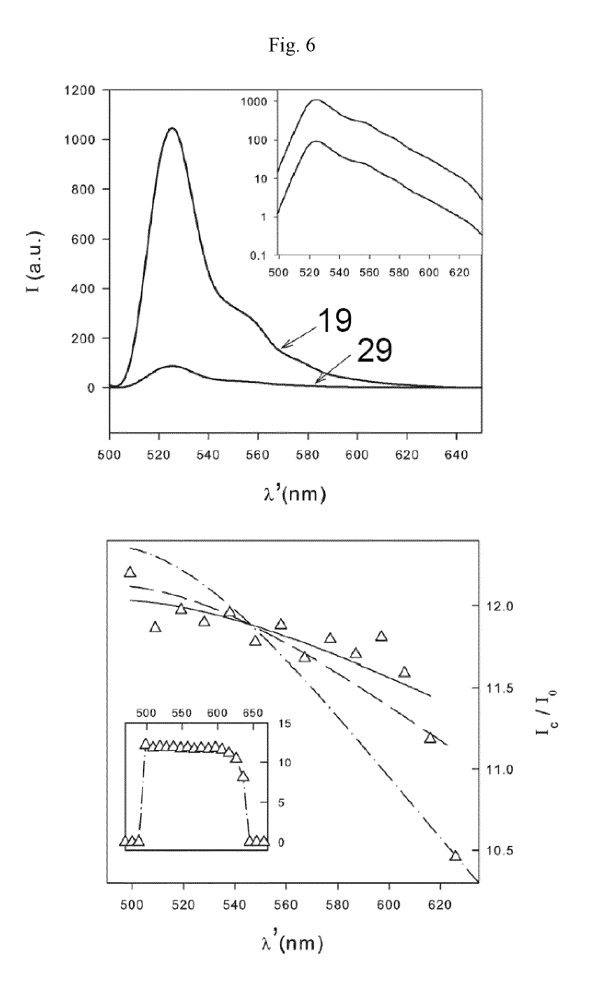

FIG. 6a shows the emission spectrum obtained for a fluorescent bead on a layer structure according to FIG. 1;

FIG. 6b shows the change in the emission spectrum of FIG. 6a as a function of the emission wavelength;

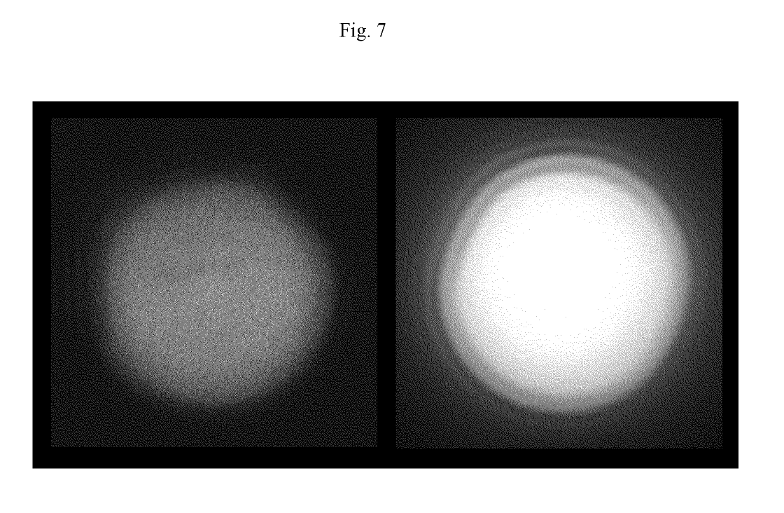

FIG. 7 shows the emission intensity of a fluorescent bead on a conventional quartz substrate (panel a), and the emission intensity in case the fluorescent bead is placed upon the layer structure of FIG. 1 (panel b);

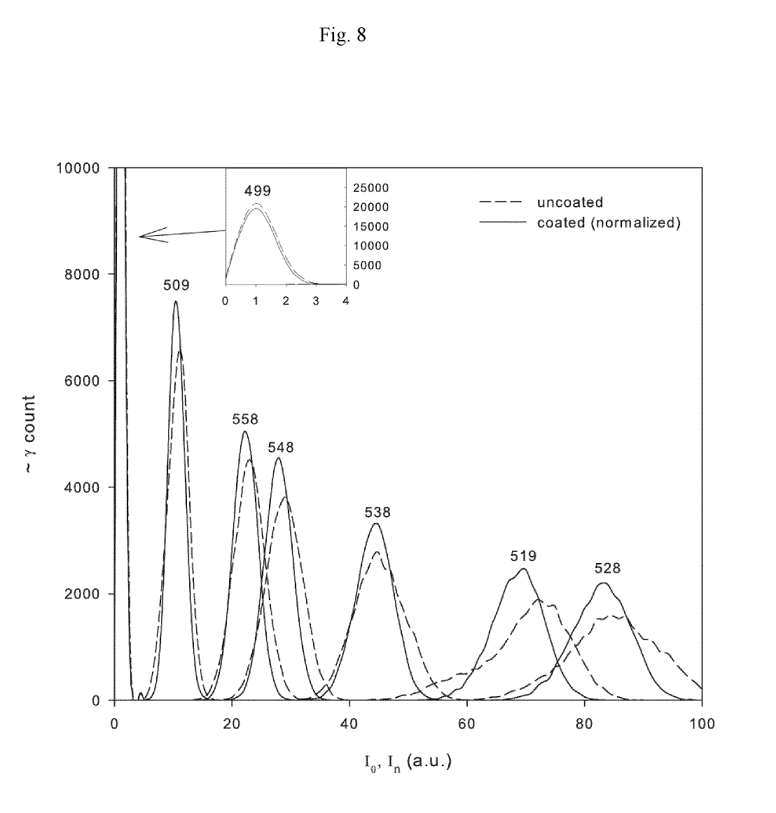

FIG. 8 shows a plot of the photon intensity distribution for different emission wavelengths of a fluorescent bead in the presence and in the absence of a layer structure according to FIG. 1, respectively;

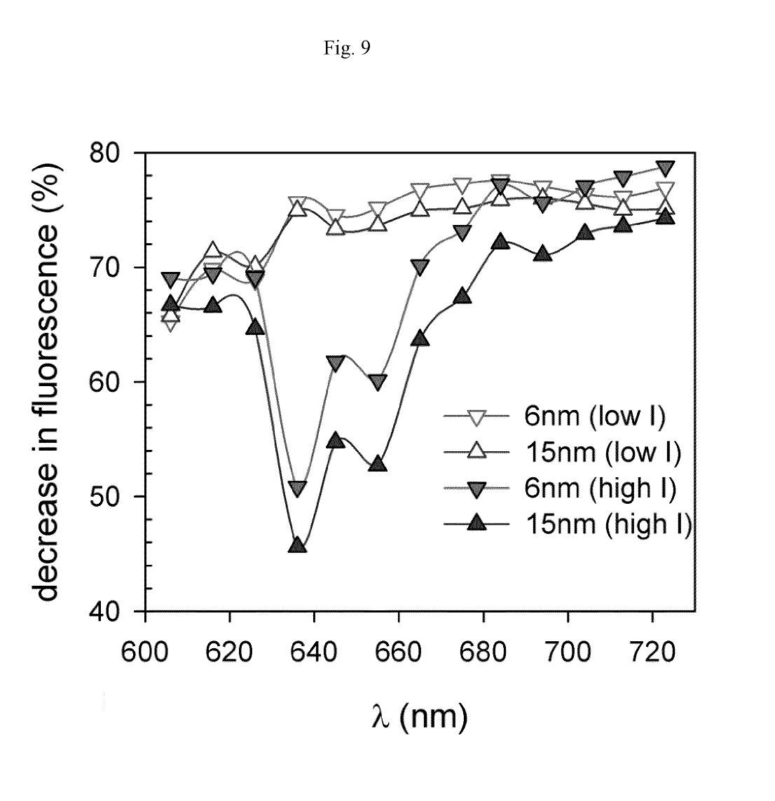

FIG. 9 shows the measured fluorescence from a fluorophore on a thin smooth metal film according to a prior art configuration;

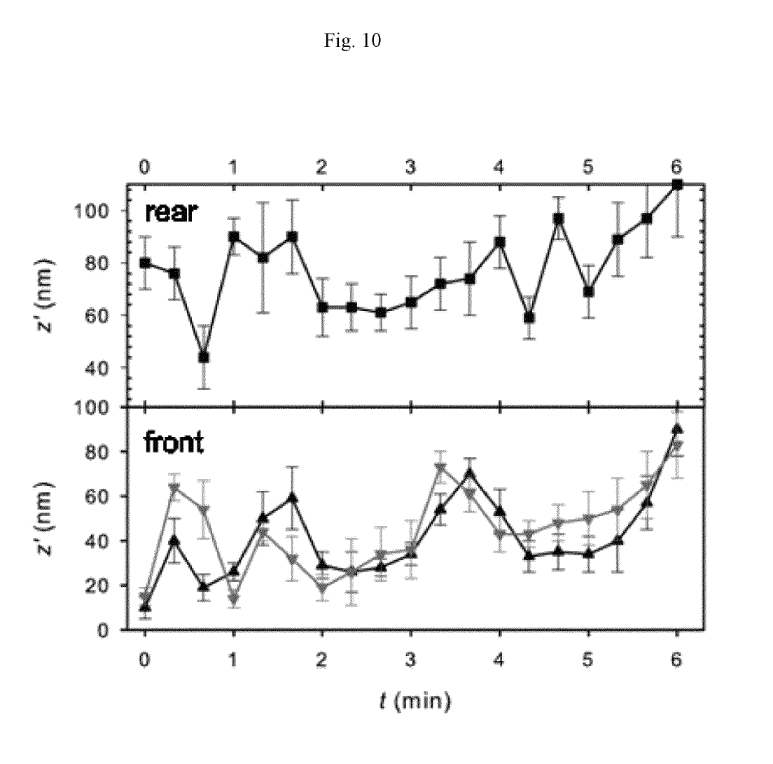

FIG. 10 shows the dynamics of GFP labeled paxilin on B16 fibroblasts; and

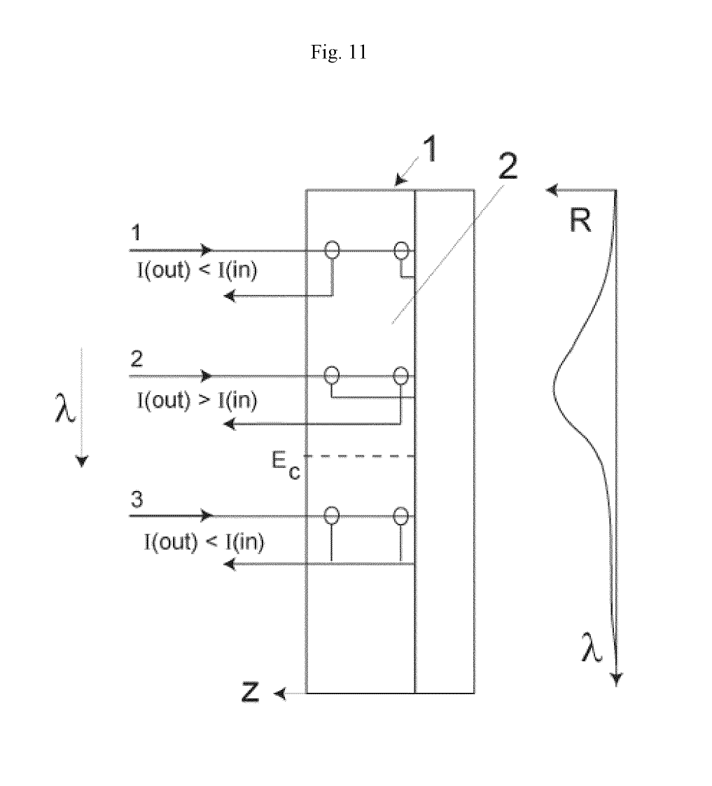

FIG. 11 schematically shows the bandpass filtering of an excitation radiation with a layer structure according to FIG. 1.

FIG. 1 shows a layer structure 1 for modifying the radiation emitted from an excited emitter 2 placed in the vicinity thereof by coupling between the excited electronic structure of the emitter 2 and a surface state of the layer structure 1, in particular a surface plasmon polariton. The emitter 2 is excited by an excitation radiation with a wavelength λ (or a band of excitation wavelengths λ); a radiation with an emission wavelength λ′ (or a band of emission wavelengths λ′) emerges from the emitter 2. The layer structure 1 comprises a metal layer 3 sandwiched between a non-metal superstrate layer 4 and a non-metal substrate layer 5; in the shown embodiment, the metal layer 3 comprises a metal layer 3′ (e.g. Ag) grown upon a metal wetting layer 3″ (e.g. Ge). The superstrate layer 4 has a planar surface 6 for placing the emitter 2 thereupon. As can be seen from FIG. 1, the substrate layer 5 and the metal layer 3, as well as the metal layer 3 and the superstrate layer 4, are separated by planar interfaces 7 and 8, respectively. The metal layer 3 is devoid of any lateral structuring in the plane of the layer structure 1. In the shown embodiment, at least the interface 8 between the metal layer 3 and the superstrate layer 4, preferably also the interface 7 between the substrate layer 5 and the metal layer 3 and the surface 6 of the superstrate layer, is smooth with a root mean square roughness Δx equal to or less than 1 nanometer, preferably less than 0.5 nm. The metal layer 3 has a thickness of between 1/100 and 1/20 in relation to the emission wavelength λ′ of the emitter 2, which is advantageously modified, in particular enhanced, in the presence of the layer structure 1, as will be explained below with respect to FIGS. 2 and 3. The superstrate layer 4 and the substrate layer 5 are made from a first and a second dielectric material (e.g. silicon nitride for the superstrate layer 4 and quartz for the substrate layer 5), which have a different permittivity to obtain an asymmetric layer structure 1.

The modification of the emission radiation achievable with the shown layer structure 1 overcomes the drawbacks of configurations known in the field of surface enhanced fluorescence, which relied upon high pumping intensities, a complex, three-dimensionally shaped coupling setups (typically a prism-like top structure or the like), and laterally structured metal structures. In the shown configuration, the modified radiative emission from the emitter 2 originates from the emitter 2 itself rather than from the layer structure 1, such that no additional limits on the lateral resolution—beyond the homogeneity achievable for thin continuous metal and dielectric films—are introduced with which the emitter can be localized.

According to an important aspect of the invention, the layer structure 1 makes use of the otherwise often undesirable energy cut-off E_{c} in the long range surface plasmon polariton (LRSPP) mode supported by the asymmetric layer structure 1 comprising the dielectric substrate layer 5, metal layer 3 and dielectric superstrate layer 4. The shown design also relies upon the finite number of excited energy transitions that many emitters 2, such as typical fluorescent dyes, can be efficiently excited to and relax through. In the shown layer structure 1, the energy cut-off E_{c} occurs above the lowest excited state of the emitter 2, but below higher excited states with sufficiently large Franck-Condon coefficients, such that the supported surface plasmon polariton excitations can serve to additionally pump the lowest excited state. This gives rise to increased emission intensities which will allow for higher lateral resolution localization and allows for realizing stimulated emission.

FIG. 2 shows a Jablonski energy diagram to model the effect for the example of a fluorescent dye. For simplicity, the fluorescent dye is assumed to have only three states: Eᵢ with i=0, 1, 2, where E₀ is the ground state and E₁ and E₂ are a first and a second excited state. However, it will be evident to the person skilled in the art that the modification effect achieved with the layer structure 1 may be modelled accordingly for different configurations. Furthermore, the diagram may also be understood as a transition energy diagram where only the energy differences between the states are interpreted (as opposed to the absolute energies in a Jablonski diagram). The two excited states E₁ and E₂ have energies E₁=E_{c}−δ/2 and E₂=E_{c}+δ/2, where E_{c} is the SPP mode cut-off energy E_{c}. The quantity δ is assumed to be on the order of the spacing between excited vibrational/rotational energy states. An arbitrary number of higher and lower excited states can be included assuming that higher excited states not in the vicinity of E_{c} will couple to the structure nonradiatively, whereas lower states will undergo internal conversion until they reach the lowest excited state where they can decay radiatively. The measurable radiative emission intensity from such a fluorescent dye with a frequency ω′ for an arbitrary excitation spectrum E(ω), when coupled to the non-radiating layer structure can be obtained from equation (2).

$${ℐ}^{r} ( ω ) ∝ {\vert {\hat{μ}}_{1}^{ex} \cdot {E}^{ex} ( {ω}_{10} ) \vert}^{2} {f}_{01} {b}_{10} ( ω ) \frac{{Γ}_{10}^{r}}{{Γ}_{1} )} + {\vert {\hat{μ}}_{2}^{ex} \cdot {E}^{ex} ( {ω}_{2} ) \vert}^{2} {f}_{02} [ {b}_{20} ( ω ) \frac{{Γ}_{20}^{r}}{{Γ}_{2}} + {b}_{10} ( ω ) \frac{{Γ}_{21} {Γ}_{10}^{r}}{{Γ}_{2} {Γ}_{1}} ] + {Δℐ}^{P} ( ω ) \qquad ( 2 )$$

Here, \hat{μ}ᵢ^{ex} is the excitation dipole moment for the i^{th} excited state, and Γᵢⱼ^{r} (Γᵢⱼ^{nr}) are the radiative (non-radiative) transition rates between the states i and j, Γᵢ is the total decay rate of state i given by Γᵢ=Γᵢ⁰+Γᵢ′, where Γᵢ⁰ is the total decay rate in the absence of the structure and Γᵢ′ is the increase in the decay rate due to the structure, bᵢⱼ(ω′) is the radiative broadening given by a Lorentzian centered at ω=ωᵢⱼ evaluated at ω=ω′, and fᵢⱼ are the Franck-Condon coefficients between states i & j. The first line in equation (2) is the contribution from excitation to and radiative decay from the state Eₗ, and the second line is the contribution from excitation to E₂ and corresponding radiative decay (directly and via E₁, respectively). For simplicity, merely spontaneous radiative decay is considered and all multi-photon events, triplet state coupling and photobleaching is neglected. A total quantum efficiency of unity is also assumed. The final term in equation (2), ΔI^{P}(ω), results from coupling between the second excited state and the first excited state via the layer structure. This can be seen to be significant due to the high field intensity near the interface (cf. FIG. 3 for the case of the distance dependence of the transverse magnetic field magnitude in an optimized layer structure comprising Quartz/Ge/Ag/Si3N4/H2O). This also gives rise to a much reduced lifetime and thus significant energy broadening, and is given by equation (3)

$${Δℐ}^{P} ( ω ) ∼ {\vert {μ}_{1}^{ex} \cdot {E}_{2}^{P} ( {ω}_{10} ) \vert}^{2} {f}_{01} \frac{{Γ}_{10}^{r}}{{Γ}_{1}} {b}_{10} ( ω ) , \qquad ( 3 )$$

where E₂^{P} (ω₁₀) is the back reacted field from the layer structure evaluated at ω→ω₁₀, which is given by equation (4).

$${E}_{2}^{P} ( {ω}_{10} ) = {f}_{02} {\vert {μ}_{2}^{ex} \cdot {E}^{ex} ( {ω}_{20} ) \vert}^{2} {f}_{02} \frac{{Γ}_{2}^{P}}{{Γ}_{2}} {E}_{R} ( {ω}_{20} ) {w}_{21}^{P} \qquad ( 4 )$$

Here, the term w₂₁^{P} accounts for the finite energy width for a resonantly excited mode, which is a consequence of its finite lifetime. For the SPP resonance this may be estimated by a Lorentzian

w₂₁^{P}=(2π)⁻¹Γ₂^{P}[(w₂−w₁)²+(Γ₂^{P}/2)²]⁻¹

The modification to the decay rates from the presence of the layer structure can be obtained with a good accuracy using a classical dipole treatment that yields results comparable to a full quantum mechanical treatment for small emitters and emitter-superstrate distances larger than −10 nm. For the case of a perpendicular (□) and parallel (∥) orientated dipole the increase in the decay rate can be written as in equation (5).

$${Γ}^{′} = \frac{3}{2 μ} \frac{{ɛ}_{1}}{{k}_{1}^{3} μ} {Γ}^{0} Im [ {E}_{R}^{⊥ , ∥} ] \qquad ( 5 )$$

In equation (5), the reflected fields E_{R} are given by equations (6) and (7).

$$\begin{matrix}{E}_{R}^{⊥} ( {u}^{-} , {u}^{+} , {z}^{′} ) = \frac{{k}_{1}^{3} μ}{{ɛ}_{1}} {\int }_{{u}_{-}}^{{u}^{+}} d u \frac{{u}^{3}}{{𝓁}_{1}} {r}_{p} {e}^{- 2 {𝓁}_{1} {k}_{1} {z}^{′}} & ( 6 ) \\ {E}_{R}^{‖} ( {u}^{-} , {u}^{+} , {z}^{′} ) = - \frac{{k}_{1}^{3} μ}{2 {ɛ}_{1}} {\int }_{{u}_{-}}^{{u}^{+}} d u \frac{u}{{𝓁}_{1}} [ ( 1 - {u}^{2} ) {r}_{p} + {r}_{s} ] {e}^{- 2 {𝓁}_{1} {k}_{1} {z}^{′}} . & ( 7 )\end{matrix}$$

In equation (5), Γ⁰ is the decay rate in the absence of the layer structure 1, z′ is the distance between the fluorescent dye and the layer structure 1, μ is the dipole moment, rₚ and rₛ are the p- and s-polarization reflection coefficients which can be determined from the transfer matrices (i.e. the Fresnel equations). The total decay rate of a state i would be given by Γi=Γ0+Γ′, where the integration range in equations (6) & (7) are [u⁺, u⁻]=[0, ∞]. For the contribution from a particular mode, the limits are defined by the transverse wavevector width of the mode as determined by the mode losses, i.e. u^{±}˜[k′ₓ^{sb}±k″ₓ^{sb}]k₀⁻¹ for the S_{b} mode.

The total measurable radiative decay rate from the emitter is given by Γᵢ^{r}=Γᵢ⁰+Γ′, where Γ′ is given by equations (5) and (2). Finally, for both components of the reflected field E_{R} equations (8) and (9) are obtained.

$$\begin{matrix} {E}_{R}^{⊥} ( {z}^{′} ) = \frac{{k}_{1}^{3} μ}{2 {ɛ}_{1}} {\int }_{0}^{α} \frac{{u}^{3}}{{𝓁}_{1}} [ ( 1 - {\vert {r}_{p} \vert}^{2} ) + 2 {r}_{p} {e}^{- 2 {𝓁}_{1} {k}_{1} {z}^{′}} ] d u & ( 80 \\ {E}_{R}^{‖} ( {z}^{′} ) = \frac{{k}_{1}^{3} μ}{4 {ɛ}_{1}} {\int }_{0}^{α} \frac{u}{{𝓁}_{1}} [ ( 1 - {\vert {r}_{s} \vert}^{2} ) + ( 1 - {u}^{2} ) ( 1 - {\vert {r}_{p} \vert}^{2} ) - [ {r}_{s} + ( 1 - {u}^{2} ) {r}_{p} ] {e}^{- 2 {𝓁}_{1} {k}_{1} {z}^{′}} ] d u & ( 9 )\end{matrix}$$

Here, the integration limit α=sin θₘₐₓ, where θₘₐₓ is the maximum detection angle. It follows that due to the strong frequency dependence of equations (5)-(9) in the vicinity of the cut-off energy that by measuring the modification of the emission spectrum with a suitable objective as a result of the presence of the shown layer structure, one can infer the separation between the nanolayer and a multi-level emitter.

Thus, the Jablonski Energy diagram of FIG. 2 demonstrates for the fluorescent dye that the excited states of the emitter 2 couples to an asymmetric layer structure 1 differently for E>E_{c} and E<E_{c} (where E_{c} is the SPP cut-off energy).

The lower panels of FIG. 2 schematically show the layer structure 1 (wherein the fluorescent emitter 2 is indicated by μ), along with the transverse magnetic amplitudes H_{y} for the bound-symmetric S_{b} (above and below the cut-off energy E_{c}), the bound-antisymmetric a_{b}, and the leaky symmetric sₗ modes. Arrows indicate directions of energy flow when coupling to the emitter 2.

In the three state model discussed above, the enhanced emission occurs only around the frequency ω₀₁. However, even for the case of a realistic multi-excited level emitter one would expect a relative enhancement for transitions E<E_{c}. This magnitude increase in intensity may thus be used to infer the distance between the fluorescent dye and the metal layer to a high precision, as can be obtained from FIG. 3 (cf. also FIG. 11).

FIG. 3 shows the transverse magnetic amplitude H_{y} across the layer structure 1 and a sample medium (e.g. water) comprising the emitter 2 on top, which illustrates the distance dependance of the magnitude of the magnetic amplitude H_{y}.

FIG. 4 shows a schematic view of an arrangement 9 for performing an imaging method of detecting the radiation emerging from the emitter 2 (e.g. a fluorophore). The emitter 2 is arranged above the layer structure 1. The layer structure 1 for holding the emitter 2 (or a plurality of such emitters 2) is preferable in the form of a coating on a suitable substrate 10, which may be a conventional microscope slide made of quartz. A fluorescent image (e.g. of a specimen stained with the emitter 2, e.g. a fluorescent dye or marker) is generated by reflected, transmitted, or evanescent illumination within a fluorescence microscope setup. The arrangement 9 comprises a light source 11 (e.g. a lamp or a laser) for emitting (laser) light (in particular visible light), which is used as an excitation radiation for exciting the emitter 2. A dichroic mirror 12 is provided for reflecting the (preferably narrow-band) excitation radiation into the direction of the emitter 2. The excitation radiation is focussed with an objective lens 13. The focused laser radiation is applied to the emitter 2, which is placed upon the transparent substrate 10 coated with the layer structure 1 as described above. The arrangement 9 further comprises an emission filter 14 for emission wavelength λ selection. A tube lens 15 is arranged for forming a real image. The radiation emerging from the emitter 2, which could be fluorescent light or a related radiation phenomenon (phosphorescence etc.), is detected with a detector 16. A stage 17 and/or scanning mirror system 18 is provided to allow for scanning a specimen comprising an ensemble of emitters 2, while moving the specimen and the laser light relative to one another.

### EXAMPLE A

In a first example, a metal layer 3 (preferably made of Ag) with a thickness of between 5-25 nm was fabricated using standard physical vapour deposition (PVD) techniques on top of a 1-2 nm thick Ge wetting layer 3″ coated quartz or glass substrate 5, 10 (also deposited using PVD). For the “load” superstrate layer 4 high purity Si₃N₄ was deposited on the metal layer 3 by PVD. Accuracy in the thickness of the individual layers of the layer structure 1 was below nanometer range, as determined by both in situ quartz crystal thickness monitor measurements and post fabrication measurements using elipsometry. The roughness, as determined by AFM tapping mode measurements, was less than 0.4 nm (RMS) for the Ag interface 8. The corresponding roughness of the Quartz substrate 5, 10, the Ge wetting layer 3″ and the surface 6 of the “load” dielectric superstrate layer 4 (also measured by AFM) were all less than 0.5 nm (RMS), which proved to be suitable for observing an advantageous effect in the modification of the radiation emerging from the emitter 2.

For the preparation of the specimen under investigation, B16F1 mouse melanoma cells and NIH 3T3 mouse fibroblasts (from American Type Culture Collection) were maintained in highglucose Dulbecco's modified eagle medium (DMEM) supplemented with 1% penicillin, 1% streptomycin, 1% glutamine and 10% fetal calf serum (PAA Laboratories) at 37° C. in the presence of 5% CO₂.

The prepared cells were then plated onto layer structure 1 coated quartz substrates which were additionally coated with 25 mg/ml laminin (Sigma-Aldrich, Austria) and incubated at 37° C. for at least 4 hours. The cells were simultaneously fixed for 15 minutes in 4% paraformaldehyde in cytoskeleton buffer (CB: 10 mM MES, 150 mM NaCl, 5 mM EGTA, 5 mM glucose, and 5 mM MgCl2, pH 6.1) and extracted with 0.2% Triton X-100 in CB for 1 minute. Immunostaining was performed using a monoclonal mouse antibody against Paxillin (BD Transduction Laboratories), dilution 1:1000 in 1% BSA (bovine serum albumin) in PBS buffer. The secondary antibody (dilution 1:750) was a goat anti-mouse antibody coupled to Alexa488 (by Invitrogen).

Fluorescence microscopy on samples using the above described coated substrates as the base was performed. Test samples consisted of individual dyes or fluorescent beads diluted and thinly coated on the substrates. Live cells were cultured on the laminin coated substrates. For observing features on the upper surfaces of fixed cells—as was of interest for the case of the Trypon Be studied—the setup consisted of placing the layer structure 1 on top of the cell and imaging through the cell and the thin (<0.3 nm) cover glass that the cell was grown on. All fluorescence studies were performed through a standard cover class (see FIG. 3) on either a Zeiss LSM 710 (using a 63×1.4 NA immersion objective) or a modified Zeiss Z1.Observer (using a 63×1.2 NA water immersion objective) and collected with an (Andor iXon+) EMCCD camera. The setup and acquisition was controlled using in the Zeiss Zen platform or by a custom Labview program for the former and latter setups, respectively. Illumination at wavelengths of 400 nm, 465 nm, 525 nm were provided using LED sources (Precisexcite, COOLED™), and coherent excitation using a Krypton/Argon mixed gas laser (488 nm and 568 nm) and blue diode laser (405 nm). Analysis and relevant filtering was performed using Matlab (Mathworks, USA).

Sectioning was achieved by performing numerical analysis based on equations (1) to (9) on the measured emission spectrum. The latter was measured using a PhotoMultiplier Tube (PMT) array (QUASAR-Quiet Spectral Array, Zeiss) with 3 nm resolution over the range of λ=450→800 nm, attached to a Zeiss LSM 710 microscope.

FIG. 5 shows images of Alexa488 (Invitrogen) labelled paxillin (found at adhesion sites) in NIH 3T3 cells. From left to right, FIG. 5 shows images obtained with an uncoated substrate (a), with a layer structure 1 coating (optimized for green fluorescence) in aqueous solution (b), and with a layer structure 1 coating in a mounting medium with a refractive index of typical immersion oil (c), respectively; the lower panels show DIC/phase contrast images of the cells. The images are confocal images (1 Airy unit pinhole) with 1.2 NA immersion objectives. The coherent excitation is at a wavelength of 488 nm.

### EXAMPLE B

Fluorescent molecules and small single- and multicolour fluorescent (red, green, blue) beads, diluted in n=1.56 mounting medium (Invitrogen) were pipeted on the substrate coated with the layer structure 1 and covered with a conventional cover slip through which imaging was performed. Imaging and spectral analysis were performed using the arrangement 9 and techniques as described above with respect to example A.

FIG. 6a shows the measured emission spectrum of green beads (Invitrogen MultiSpec™) on a Quartz/Ge/Ag/Si₃N₄ layer structure 1 with the parameters given by the last entry in table (1). A widefield excitation radiation from a coherent source 11 and imaging through a 63×NA1.4 oil-immersion objective was use. As can be obtained from FIG. 6a, the emitted radiation is significantly enhanced by the layer structure 1 (cf. above line, indicated at 19) compared to the radiation obtained with the conventional design (cf. below line, indicated at 20).

FIG. 6b shows the change in the emission spectrum as a function of the emission wavelength λ′. The rate of decrease in the emission radiation with increasing wavelength λ′ can be used to deduce the distance between the emitter 2, i.e. the fluorophore, and the layer structure 1. The fitted curves are squared Lorenzians with different distance parameters varying by 10 nm. The middle curve constitutes the best (χ²) fit for this data set and corresponds to a distance of 30 nm. The inset shows the decrease over the entire measured spectrum. For this structure, the cut-off wavelength λ_{c} is in the range of 2πc/ω_{c}≈500-600 nm.

FIG. 7 shows the emission intensity I (between 523 nm<λ<533 nm) for a fluorescent bead on a plain quartz substrate (cf. panel a) and a fluorescent bead on a substrate 5, 10 with the layer structure 1 (cf. panel b). The relevant parameters are essentially identical as in the example of FIG. 6. The two fluorescent beads were imaged on the same quartz slide of which only approximately half (corresponding to panel b) was coated with the layer structure.

FIG. 8 shows a plot of the photon intensity distribution for different emission wavelengths λ′ (labelled on graph), wherein the high intensity for fluorophores on coated substrates (solid lines) has been scaled to that of the conventional, uncoated substrate (dashed lines) for comparison. The relative increased number of photons at defined intensities (narrowing of the peaks) can be explained as a consequence of the plasmon coupling.

### EXAMPLE C

The layer structure 1 is also advantageous for investigations involving photoactivatable proteins. Efficient coupling of the high excited state to a long lived bound mode in the layer structure 1 can enhance the field intensity at the lower (activated) transition energy and increase the radiative decay or induce significant radiative decay with just an activation source. To demonstrate this use, the paGFP labelled MORN protein in trypanosoma brucei cells was investigated. Since this protein is found in the vicinity of the cell surface, the cells were grown on a conventional cover slip and the layer structure 1 was compressed against the surface thereof. Conventional and spectral imaging, as described before, was subsequently performed through the cell.

FIG. 9 shows that the fluorescence of a fluorophore is reduced in the immediate vicinity of thin (6 nm and 12 nm thick) ultra-smooth Ag films. Thus, in contrast to the layer structure 1 as discussed above, providing a smooth metal surface alone results in quenching of the obtained fluorescence. The fluorophore was a red bead (Invitrogen MultiSpec™) excited at 561 nm (coherent), with photophysical porperties comparable to Alexa561. A widefield excitation and imaging with a 63×NA1.4 oil-immersion objective was deployed.

FIG. 10 shows the dynamics of GFP labeled paxilin on B16 fibroblasts on top of the layer structure 1. The change in the emission spectrum (490 to 700 nm) in a 1×1 micron square at adhesion sites in the front (lower panel) and the rear end (upper panel) of a cell was analyzed. The change in the short wavelength λ′ emission relative to the long emission wavelength λ′ emission was used to infer the distance perpendicular to the layer structure 1 (measured from the surface 6 of the layer structure 1). The results reveal an up and down movement of the protein over a sub 100 nm scale close to the surface 6. Thus, providing the layer structure 1 makes precise dynamical measurements possible.

FIG. 11 illustrates the application of the layer structure 1 to the bandpass filtering of an excitation radiation. A gain medium 21 comprising an ensemble of emitters 2 is arranged above the layer structure 1. An excitation radiation with an intensity I(in) is coupled into the gain medium 21 and a reflected emission radiation with an intensity I(out) is obtained. The excitation radiation spans a spectrum of excitation wavelengths λ. Due to the interaction with the emitters 2, the excitation radiation is largely attenuated for a short wavelength range 1 and a large wavelength range 3, whereas the excitation radiation is enhanced for an intermediate wavelength range 2 above the energy cut-off E_{c} resulting in a comparatively high reflection coefficient R (see right-hand side diagram). The enhancement in range 2 is due to the presence of the layer structure 1, as described above. On the other hand, in range 1 the SPP modes do not decay far into the gain medium 21, such that coupling between the emitters 2 and the layer structure 1 is weak and the respective excitation wavelengths λ are attenuated. Also, below a certain excitation wavelength λ (range 3) the enhancement effect gradually disappears and a decrease in the obtained emission radiation λ′ compared to the excitation above the cut-off energy E_{c} is observed. It will be apparent to the person skilled in the art, that the layer structure 1 can also be used to achieve a population inversion of emitters 2 in the vicinity thereof.

1. A method of modifying a radiation characteristic of an excited emitter (2), wherein the emitter (2) is placed in the vicinity of a layer structure (1) comprising a metal material, such that the emitter (2) couples to a surface state of the layer structure (1), in particular a surface plasmon polariton, which modifies the radiation characteristic of the emitter (2), characterized in that the layer structure (1) comprises a metal layer (3) sandwiched between a non-metal superstrate layer (4) and a non-metal substrate layer (5), wherein at least the metal layer (3) and the superstrate layer (4) are separated by a smooth interface (8) with a root mean square roughness equal to or less than 1 nanometer, and wherein the metal layer (3) has a thickness of between 1/100 and 1/20 in relation to an emission wavelength (λ′) of the emitter (2).

2. The method according to claim 1, characterized in that the smooth interface (8) is produced by deposition of a wetting layer (3″) onto the substrate layer (5) and/or in a template stripping method.

3. The method according to claim 1, characterized in that a permittivity of the dielectric superstrate layer (4) differs from a permittivity of the substrate layer (5).

4. The method according to claim 1, characterized in that the metal layer (3) is formed by a metal material selected from the group consisting of silver, gold, palladium, nickel, chromium, aluminium, aluminium-zincoxide, gallium-zinc-oxide, cadmium or an alloy thereof.

5. The method according to claim 1, characterized in that the superstrate layer (4) is formed by a material selected from the group consisting of aluminium oxide, silicon dioxide, titanium dioxide, silicon nitride, silicon carbide, or a polymer.

6. The method according to claim 1, characterized in that the emitter (2) emits radiation at an emission wavelength (λ′) of between 250 nm and 1600 nm, preferably between 405 nm and 600 nm.

7. The method according to claim 1, characterized in that the modified radiation from the emitter (2) in the vicinity of the layer structure (2) is used for imaging of a sample comprising the emitter (2).

8. The method according to claim 7, characterized in that the imaging of the sample is performed with a microscope arrangement (9) comprising a microscope slide, which is coated with or consists of the layer structure (1) for modifying the radiation from the sample comprising the emitter (2) placed upon the non-metal superstrate layer (4) of the layer structure (1).

9. The method according to claim 1, characterized in that the emitter (2) is a fluorophore emitting fluorescent light, in particular a fluorescent dye.

10. The method according to claim 1, characterized in that the modified radiation from the emitter (2) in the vicinity of the layer structure (1) is used for determining a position of the emitter (2) and/or for measuring a distance between the emitter (2) and the layer structure (1).

11. The method according to claim 1, characterized in that the modification of the radiation characteristic of the emitter (2) in the vicinity of the layer structure (1) is used for bandpass or bandstop filtering.

12. The method according to claim 1, characterized in that the modification of the radiation characteristic of the emitter (2) in the vicinity of the layer structure (1) is used for stimulated emission from the emitter (2).

13. A layer structure (1) with a metal material for modifying a radiation characteristic of an excited emitter (2) placed in the vicinity thereof by coupling between the emitter (2) and a surface state of the layer structure, in particular a surface plasmon polariton, characterized in that the layer structure (1) comprises a metal layer (3) sandwiched between a non-metal superstrate layer (4) and a non-metal substrate layer (5), wherein at least the metal layer (3) and the superstrate layer (4) are separated by a smooth interface (8) with a root mean square roughness equal to or less than 1 nanometer, and wherein the metal layer (3) has a thickness of between 1/100 and 1/20 in relation to an emission wavelength (λ′) of the emitter (2).
